(19) United States
(12) Patent Application Publication
(10) Pub. No.: US 2026/0119212 A1
(43) Pub. Date: Apr. 30, 2026

(54) SYSTEMS AND METHODS FOR DISPLAYING CONTENT FROM ANOTHER ELECTRONIC DEVICE

(71) Applicant: Apple Inc., Cupertino, CA (US)

(72) Inventors: Aakriti MITTAL, Campbell, CA (US); David COHEN, Longmont, CO (US); Kyle C. BROGLE, San Francisco, CA (US)

(21) Appl. No.: 19/003,886

(22) Filed: Dec. 27, 2024

Related U.S. Application Data
(60) Provisional application No. 63/654,810, filed on May 31, 2024.

(51) Int. Cl. G06F 9/451; H04L 9/08; H04W 12/50

(52) U.S. Cl. CPC G06F 9/452; H04L 9/0819; H04W 12/50

(57) ABSTRACT

An electronic device associated with a respective user account presents content from another electronic device associated with a different user account. In some embodiments, a first electronic device associated with the user account of a first user establishes a connection with a second electronic device associated with the user account of a second user. Using this connection, the first electronic device and second electronic device exchange authentication keys, including authentication keys of the first electronic device, the second electronic device, and a third electronic device also associated with the user account of the second user. In some embodiments, in response to detecting an advertisement of the authentication key of the third electronic device broadcast by the third electronic device, the first electronic device initiates a process to present content received from the third electronic device.

### CROSS-REFERENCE TO RELATED APPLICATIONS

This application claims the benefit of U.S. Provisional Application No. 63/654,810, filed May 31, 2024, the entire disclosure of which is herein incorporated by reference for all purposes.

### FIELD OF THE DISCLOSURE

Aspects of the present disclosure relate to displaying content from one electronic device associated with a respective user account with another electronic device associated with a different user account.

### BACKGROUND OF THE DISCLOSURE

Electronic devices display various content, including user interfaces of applications. In some situations, an electronic device displays content using a display component. In some situations, an electronic device displays content using another electronic device. When displaying content using another electronic device, the electronic device communicates with that other electronic device.

### SUMMARY OF THE DISCLOSURE

Aspects of the present disclosure relate to displaying content from one electronic device associated with a respective user account with another electronic device associated with a different user account. In some embodiments, a first electronic device associated with the user account of a first user establishes a connection with a second electronic device associated with the user account of a second user. Using this connection, the first electronic device and second electronic device exchange authentication keys, including authentication keys of the first electronic device, the second electronic device, and a third electronic device also associated with the user account of the second user. The first electronic device optionally detects an advertisement of the authentication key of the third electronic device broadcast by the third electronic device. In some embodiments, in response to detecting the advertisement of the authentication key of the third electronic device, the first electronic device initiates a process to present content received from the third electronic device.

In some embodiments, the first electronic device presents the content from the third electronic device while operating in a mode configured for use by the second user that is different from an operation mode configured for use by the first user. For example, the mode configured for use by the second user includes a limited set of permissions compared to the permissions associated with the operation mode configured for use by the first user.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1 is a block diagram illustrating a plurality of electronic devices in communication with a server and/or with one or more other electronic devices according to some embodiments of the disclosure.

FIG. 2 is a data flow diagram illustrating a method of exchanging authentication keys between the first electronic device and the third electronic device according to some embodiments of the disclosure.

FIG. 3A illustrates an exemplary method of presenting content using the first electronic device that is from the third electronic device according to some embodiments of the disclosure.

FIG. 3B illustrates an exemplary method of presenting content associated with a second user account using an electronic device associated with a first user account according to some embodiments of the disclosure.

FIG. 4 is an example block diagram of an electronic device according to some embodiments of the disclosure.

### DETAILED DESCRIPTION

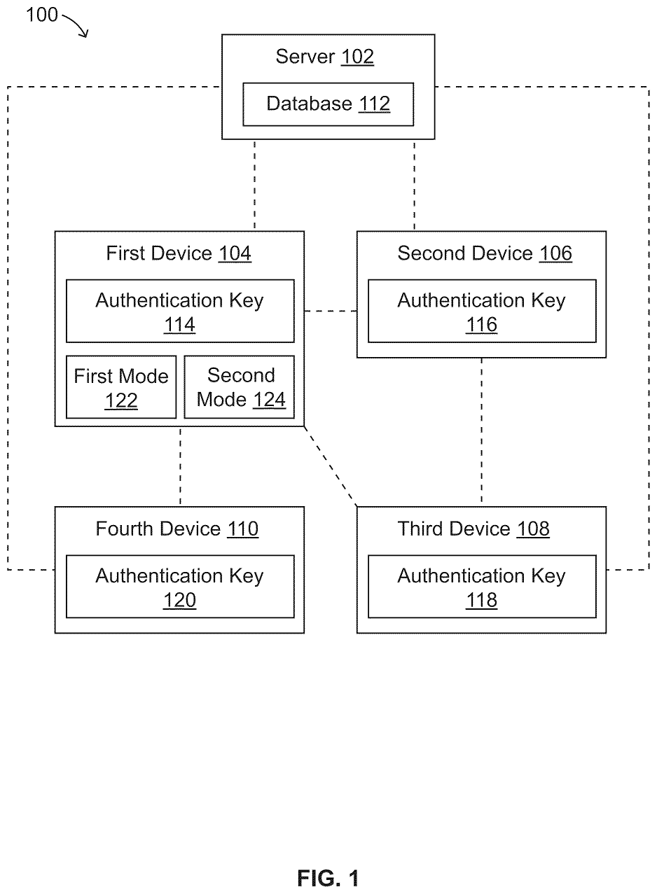

FIG. 1 is a block diagram 100 illustrating a plurality of electronic devices 104, 106, 108, and 110 in communication with a server 102 and/or with one or more other electronic devices according to some embodiments of the disclosure. In some embodiments, the electronic devices 104 through 110 are in communication with the server via an internet connection. The server 102 stores a database 112 that includes data associated with one or more user accounts of the electronic devices 104 through 110.

In some embodiments, user accounts can be associated with more than one electronic device. In this way, it is possible for a user to synchronize user data, such as settings, files, and/or software services or communication accounts across multiple electronic devices that the user uses. Optionally, the server 102 stores this and/or other user data in database 112. For example, first electronic device 104 and fourth electronic device 110 are associated with the user account of a first user and second electronic device 106 and third electronic device 108 are associated with the user account of a second user.

In some embodiments, the electronic devices 104 through 110 store respective authentication keys associated therewith (e.g., authentication keys 114 through 120). In some embodiments, the authentication keys are identity resolving keys (IRKs) of the respective electronic devices (e.g., electronic devices 104 through 110). For example, the first electronic device 104 stores authentication key 114 associated with the first electronic device 104; the second electronic device 106 stores authentication key 116 associated with the second electronic device 106; the third electronic device 108 stores authentication key 118 associated with the third electronic device 108; and the fourth electronic device 110 stores authentication key 120 associated with the fourth electronic device 110. In some embodiments, the authentication keys enable the electronic devices to communicate with one another, such as to use one electronic device to display content from another electronic device. By controlling which other electronic devices have access to a respective authentication key, an electronic device is able to control which other electronic devices are able to send and/or receive such data. In some embodiments, electronic devices associated with a common user account have access to each other's authentication keys. For example, server 102 stores the authentication keys associated with the electronic devices of respective user accounts in database 112 in such a way that electronic devices 104 through 110 have access to the authentication keys of other electronic devices associated with the same user account and do not have access to authentication keys of other electronic devices associated with other user accounts (e.g., until shared by device associated with the other user accounts).

Electronic devices 104 through 110 can be of a variety of architectures. For example, electronic devices 104 through 110 include one or more of head-mounted devices, smartphones, personal computers, tablets, media players, and/or set top boxes. In an example, first electronic device 104 is a head-mounted device including a head-mounted display configured to present a three-dimensional environment to the user of the first electronic device 104. Example three-dimensional environments include augmented reality (AR) environments, extended reality (XR) environments, and/or virtual reality (VR) environments. In an example in which the first electronic device 104 is a head-mounted device, the second electronic device 106 is optionally a smartphone and the third electronic device 108 and the fourth electronic device 110 are optionally personal computers. In this example and as described above, the first device 104 and fourth electronic device 110 are associated with a user account of a first user and the second electronic device 106 and the third electronic device 108 are associated with a user account of a second user.

In some embodiments, the first electronic device 104 (e.g., a head-mounted device) is able to display content provided by the fourth electronic device 110 (e.g., a personal computer). The content optionally includes still or video image(s), user interface element(s), and/or audio content. Displaying content provided by the fourth electronic device 110 using the first electronic device 104 enables the user to augment a display device included in or in communication with the fourth electronic device 110 in the three-dimensional environment presented using the first electronic device 104. For example, the first electronic device 104 displays a virtual two-dimensional display including the content of the fourth electronic device 110.

To begin presenting content from the fourth electronic device 110 using the first electronic device 104, the first electronic device 104 receives an input from the user requesting to present the content from the fourth electronic device 110. In response to receiving the input, the first electronic device 104 and fourth electronic device 110 advertise their respective authentication keys 114 and 120. In some embodiments, the advertisements of the authentication keys 114 and 120 are encrypted. The first electronic device 104 and the fourth electronic device 110 optionally recognize and are able to decrypt each other's authentication keys 114 and 120 because the first electronic device 104 and the fourth electronic device 110 have access to the authentication keys 114 and 120 because they are associated with the same user account. In some embodiments, once the first electronic device 104 and fourth electronic device 110 recognize each other, they establish a secure wireless connection to each other, such as a Bluetooth connection or secure device-to-device connection other than Bluetooth. In some embodiments, the first electronic device 104 and the fourth electronic device 110 use this connection to facilitate display of the content from the fourth electronic device 110 by the first electronic device 104.

As described above, the first electronic device 104 and the fourth electronic device 110 are optionally associated with the user account of a first user. In some embodiments, access to these electronic devices is locked unless and until these devices receive login credentials of the first user, such as a password, an image of the first user (e.g., the user's face), and/or biometric data of the first user (e.g., fingerprints, iris scan). In some situations, the first user may wish to allow the second user to access the first electronic device 104 with a limited feature set. Thus, in some embodiments, the first electronic device 104 is able to operate in a first mode 122 for use by the first user or in a second mode 124 for use by users other than the first user.

In some embodiments, the second mode 124 allows access to a subset of features accessible by the first electronic device 104 in the first mode 122. For example, the second mode 124 restricts access to one or more files, applications, or other features accessible in the first mode 122. Other features not accessible in the second mode 124 optionally include payment information, communication accounts, a digital avatar, and/or connection to other electronic devices associated with the user account of the first user, such as the connection to the fourth electronic device 110. Thus, in some embodiments, while operating in the second mode 124, the first electronic device 104 restricts access to displaying content from the fourth electronic device 110. In other embodiments, the first electronic device 104 allows access to displaying content from the fourth electronic device 110 in the second mode 124, optionally with the first user's permission.

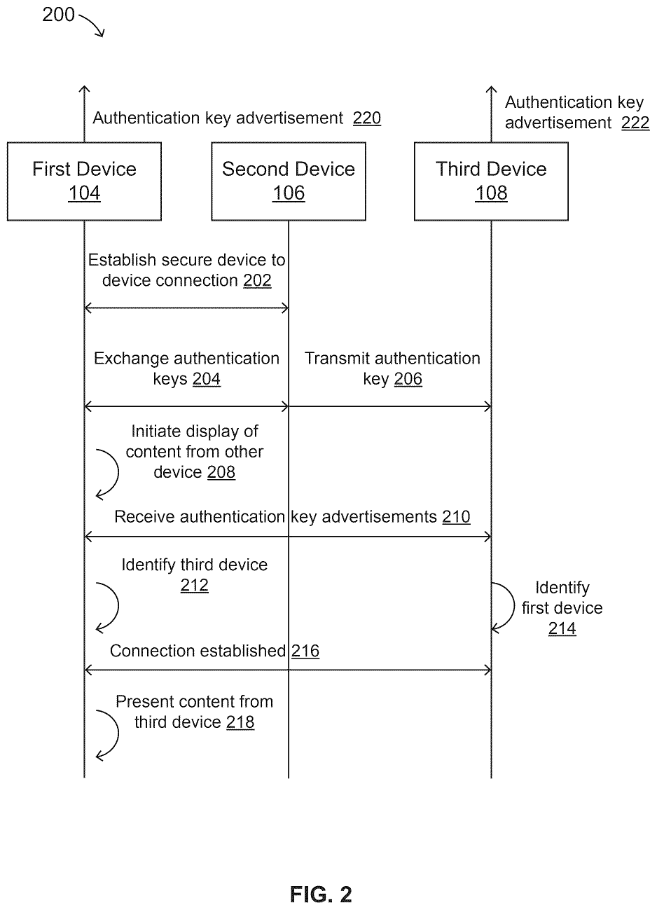

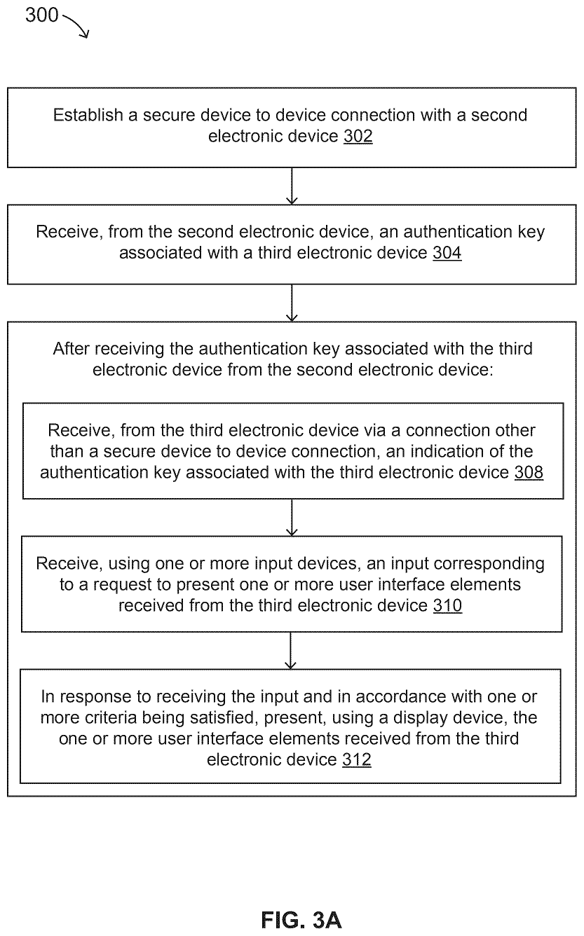

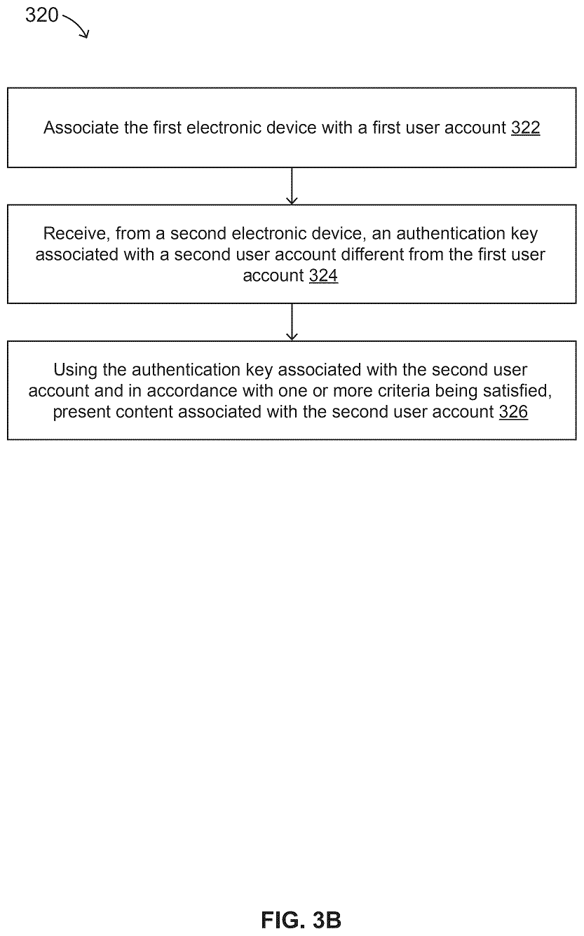

In some situations, the second user may wish to display content from the third electronic device 108 associated with the user account of the second user while using the first electronic device 104 in the second mode 124. For example, the second user may wish to view content from their personal computer while using the first user's head-mounted device. The first electronic device 104 associated with the first user account optionally presents content from the third electronic device 108 associated with the second user account as described herein with reference at least to FIGS. 2-3.

FIG. 2 is a data flow diagram 200 illustrating a method of exchanging authentication keys between the first electronic device 104 and the third electronic device 108 according to some embodiments of the disclosure. As described herein, once the authentication keys are exchanged, the first electronic device 104 presents images from the third electronic device 108. The authentication keys are optionally the authentication key 114 of the first electronic device 104 and the authentication key 118 of the third electronic device 108 described above with reference to FIG. 1.

As described above, in some embodiments, the authentication keys 114 and 118 are identity resolving keys used in wireless communications between devices, such as via Bluetooth. As shown in FIG. 2, the first electronic device 104 advertises 220 its authentication key 114 and the third electronic device 108 advertises 222 its authentication key 118. In some embodiments, the electronic devices 104 and 108 use Bluetooth to advertise their respective authentication keys 114 and 118. In some embodiments, prior to exchanging authentication keys 114 and 118 as described herein, the first electronic device 104 and third electronic device 108 cannot decrypt the authentication key advertisement 220 or 222 of the other electronic device. In some embodiments, after exchanging authentication keys 114 and 118 as described herein, the first electronic device 104 and the third electronic device 108 are able to decrypt the authentication key advertisements 220 or 222 of the other electronic device, thus enabling the first electronic device 104 to present content received from the third electronic device 108 via wireless communication.

In some embodiments, the first electronic device 104 operates in the second mode 124 (e.g., guest mode) described above during the process(es) depicted by data flow diagram 200. For example, the second user whose user account is associated with the second electronic device 106 and the third electronic device 108 is using the first electronic device 104 in the second mode 124 (e.g., guest mode). As described above, the second mode 124 (e.g., guest mode) optionally differs from the first mode 122 (e.g., owner mode) in that the second mode 124 includes a more limited feature set than the first mode 122.

Additionally or alternatively, in some embodiments, operating in the second mode 124 includes customizing aspects of operation of the first electronic device 104 for the second user. For example, the first electronic device 104 customizes the presentation of images via a head-mounted display based on eye data of the current user of the first electronic device 104 and customizes the receipt of inputs including gestures performed by fingers, hand(s), and/or arm(s) of the current user of the first electronic device 104. In the first mode 122, the first electronic device 104 operates using enrollment data of the first user, including hand and/or eye data of the first user. In the second mode 124, the first electronic device 104 operates using enrollment data of the current guest user, such as the second user, including hand and/or eye data of that user.

In some embodiments, the first electronic device 104 performs an enrollment process to collect hand and/or eye data of the second user when the second user begins using the first electronic device 104 in the second mode 124. During this process, for example, the first electronic device 104 captures image(s) of the second user's hand(s) and/or eyes and generates enrollment data for use displaying images with the head-mounted display and/or receiving inputs using one or more hand tracking devices. In some embodiments, the first electronic device 104 does not store this enrollment data after the conclusion of the second user using the first electronic device 104 in the second mode 124. In some embodiments, the first electronic device 104 undergoes the enrollment process each subsequent time the second user uses the first electronic device 104 in the second mode 124. Alternatively, in some embodiments, after collecting the enrollment data for the second user, the first electronic device 104 transmits the enrollment data to the second electronic device 106 associated with the second user's user account. In these embodiments, when the second user subsequently uses the first electronic device 104 in the second mode 124, the second device 106 transmits the user enrollment data for the second user to the first electronic device 104. In this way, for example, the first electronic device 104 is able to operate using the second user's user enrollment data without storing the second user's enrollment data and without undergoing the collection process each time the second user uses the first electronic device 104 in the second mode 124.

In some embodiments, in order to transfer the second user's user enrollment data between the first electronic device 104 and the second electronic device 106 as described above, the first electronic device 104 and the second electronic device 106 establish a secure device to device connection 202. In some embodiments, this connection is a direct wireless connection between the first electronic device 104 and the second electronic device 106 without the use of an intervening server, for example. In some embodiments, the secure device to device connection 202 leverages Bluetooth. In some embodiments, the secure device to device connection is different from a Bluetooth connection. In some embodiments in which the first electronic device 104 and the second electronic device 106 do not transfer the second user's user enrollment data, the first electronic device 104 and the second electronic device 106 establish the secure device to device connection 202 for other purposes, including content sharing described herein.

Establishing the secure device to device connection 202 between the first electronic device 104 and the second electronic device 106 optionally includes verification by the first and/or second user(s). For example, in order to verify that the connection should be established, the first electronic device 104 and the second electronic device 106 are unlocked, such as by login credentials of the first user and the second user respectively. In this example, while the first electronic device 104 and the second electronic device 106 are unlocked, the second electronic device 106 presents a pairing image and/or code using a display (e.g., a display integrated with the second electronic device 106) and the first electronic device 104 captures an image of the code using one or more cameras. Alternatively, the first electronic device 104 presents a list of nearby electronic devices, including the second electronic device 106. Optionally, in response to receiving an input selecting the second electronic device 106, the first electronic device 104 initiates the secure device to device connection with the second electronic device 106 with or optionally without capturing the authentication code presented by the second electronic device 106. Additionally or alternatively, the first electronic device 104 and the second electronic device 106 establish the secure device to device connection automatically in response to the second user logging into the first electronic device 104 with credentials associated with the user account of the second user. For example, in response to receiving the credentials associated with the user account of the second user, the first electronic device 104 operates with settings (e.g., guest mode restrictions) associated with the second user and/or communicates with server 102 to receive the authentication key 118 associated with the third electronic device 108.

Once the secure device to device connection is established between the first electronic device 104 and the second electronic device 106, the first electronic device 104 and the second electronic device 106 optionally use the secure device to device connection to exchange authentication keys 204. For example, the first electronic device 104 transfers its device authentication key 114 to the second electronic device 106 and the second electronic device 106 transfers its authentication key 116 and the authentication key 118 of the third electronic device 108 to the first electronic device 104. As described above, the second electronic device 106 stores and/or has access to the device authentication key 118 of the third electronic device 108 because the second electronic device 106 and the third electronic device 108 are associated with the same user account (e.g., the user account of the second user). For example, server 102 stores the authentication key 116 of the second electronic device 106 and the authentication key 118 of the third electronic device 108 in database 112 in association with the user account of the second user. In some embodiments, the server 102 transmits the device authentication key 118 of the third electronic device 108 and to the second electronic device 106, which stores the authentication key 118. In some embodiments, the server 102 transmits the device authentication key 118 of the third electronic device 108 to the second electronic device 106 in response to receiving a request from the second electronic device 106, and the second electronic device 106 deletes the authentication key 118 of the third electronic device 108 after using it and/or transferring it to the first electronic device 104.

In some embodiments, once the second electronic device 106 receives the authentication key 114 of the first electronic device 104 from the first electronic device 104 via the secure device to device connection, the second electronic device 106 shares the authentication key 114 with the third electronic device 108. In some embodiments, the second electronic device 106 uploads the authentication key 114 to the server 102, and the server 102 transmits the authentication key 114 to the third electronic device 108. Optionally, the authentication key 114 is encrypted when being uploaded to and/or download from server 102. Alternatively, in some embodiments, the second electronic device 106 transmits the authentication key 114 to the third electronic device 108 via a secure device to device connection without transmitting the authentication key 114 to server 102.

In some embodiments, while the second user is using the first electronic device 104 in the second mode 124, the first electronic device 104 receives an input corresponding to a request to present content from another device 208. For example, the request is to present content from the third electronic device 108. In response to receiving the input, the first electronic device 104 detects advertisements of device authentication keys being broadcast by electronic devices in its vicinity. Because the first electronic device 104 is operating in the second mode 124 and is configured for the second user, the first electronic device 104 seeks to detect authentication keys of electronic devices associated with the user account of the second user. If the first electronic device 104 was operating in the second mode 124 configured for a different user, the first electronic device 104 would seek to detect authentication keys of electronic devices associated with the user account of that user instead, for example. As another example, if the first electronic device 104 was operating in the first mode 122 associated with use by the first user, the first electronic device 104 would seek to detect authentication keys of electronic devices associated with the user account of the first user.

In some embodiments, the first electronic device 104 and the third electronic device 108 receive the authentication key advertisements 220 and 222 of each other 210, respectively. In some embodiments, the first electronic device 104 receives authentication key advertisements from multiple other electronic devices, including the authentication key advertisement 222 broadcast by the third electronic device 108. Optionally, these other electronic devices are also associated with the user account of the second user because the first electronic device 104 is operating in the second mode 124 configured for the second user. Optionally, the first electronic device 104 receives and ignores authentication key advertisements of electronic devices associated with other user accounts.

In some embodiments, in response to receiving authentication key advertisements from a plurality of electronic devices associated with the second user account, the first electronic device 104 presents a plurality of selectable options respectively associated with the plurality of electronic devices. In response to receiving an input selecting one of these options, the first electronic device 104 proceeds with the process to present content from the electronic device corresponding to the selected option. For example, the first electronic device 104 receives an input selecting an option corresponding to the third electronic device 108.

In some embodiments, the first electronic device 104 identifies the third electronic device 108 (212) based on receiving the authentication key advertisement 222 of the third electronic device 108 and matching the authentication key advertisement 222 with the authentication key 118 previously received. Likewise, the third electronic device 108 identifies the first electronic device 104 (214) based on receiving the authentication key advertisement 220 of the first electronic device 106 and matching the authentication key advertisement 220 with the authentication key 114 previously received. Once the first electronic device 104 and the third electronic device 108 recognize each other, the first electronic device 104 and third electronic device 108 establish a (e.g., wireless) connection 216. The connection 216 is optionally a Bluetooth connection. The connection 216 is optionally a secure device to device connection of the same type as the connection the first electronic device 104 and the second electronic device 106 used to exchange authentication keys 204 as described above. The connection 216 is optionally a connection of a different type from the connection the first electronic device 104 and the second electronic device 106 used to exchange authentication keys 204 as described above.

The first electronic device 104 and the third electronic device 108 use the connection 216 to facilitate using the first electronic device 104 presenting content from the third electronic device 108 (218). As described above, presenting content from the third electronic device 108 includes presenting still or video image(s), user interface element(s), and/or audio content output by the third electronic device 108 with output devices of the first electronic device 104. In some embodiments, presenting the content form the third electronic device 108 includes displaying visual content from the third electronic device 108 in a three-dimensional environment presented by the first electronic device 104. Thus, in this way, the first electronic device 104 optionally displays content associated with the user account of the second user provided by the third electronic device 108 in a three-dimensional environment generated by the first electronic device 104 using data associated with the first user account. For example, the three-dimensional environment includes additional user interface elements and/or other visual content of the first electronic device 104 configured and/or stored in association with the first user's user account. It should be understood that the first user is able to configure the second mode 124 for use by the second user to selectively allow and/or restrict access to various portions of data associated with the user account of the first user. For example, prior to the second user beginning to use the first electronic device 104 in the second mode 124 the first user configures the second mode 124 including setting desired access permissions for the session of use in the second mode 124.

Optionally, at the termination of the second mode 124 configured for the second user, the first electronic device 104 and third electronic device 108 delete each other's authentication keys. For example, the first electronic device 104 deletes authentication key 118 and optionally authentication key 116 and the third electronic device 108 deletes authentication key 114. The first electronic device 104 and the third electronic device 108 optionally delete the authentication keys 118 and 114, respectively, in accordance with one or more criteria being satisfied. The one or more criteria include detecting the end of the first electronic device 104 operating in the second mode 124, detecting a predetermined amount of time (e.g., one day to two weeks) passing since detecting the end of the first electronic device 104 operating in the second mode 124, detecting a predetermined distance between the first electronic device 104 and the second electronic device 106 and/or the third electronic device 108, and/or detecting the secure device to device connection between the first electronic device 104 and the second electronic device 106 ending.

FIG. 3A illustrates an exemplary method 300 of presenting content using the first electronic device 104 that is from the third electronic device 108 according to some embodiments of the disclosure. For example, first electronic device 104 performs method 300 to present content from third electronic device 108 while the second user uses the first electronic device 104 in the second mode 124. In some embodiments, steps of method 300 can be repeated, omitted, or performed in an order other than the order in which they are discussed without departing from the scope of the disclosure. In some embodiments, the first electronic device 104 includes a non-transitory computer readable storage medium storing instructions that, when executed, cause the first electronic device 104 to perform method 300 and/or one or more steps thereof.

At 302, method 300 includes establishing a secure device to device connection with another electronic device (e.g., the second electronic device 106). As described above with reference to FIG. 2, establishing the secure device to device connection optionally includes capturing, with the first electronic device 104, a verification code presented by the second electronic device 106. In some embodiments, the secure device to device connection is a connection between the first electronic device 104 and the second electronic device 106 without an intervening other electronic device, such as a server. In some embodiments, the secure device to device connection is different from Bluetooth. In some embodiments, the secure device to device connection leverages Bluetooth.

At 304, method 300 includes receiving, from the second electronic device (e.g., second electronic device 106), an authentication key (e.g., authentication key 118) associated with a third electronic device (e.g., third electronic device 108). As described above with reference to FIG. 1, the second electronic device 106 optionally has access to the authentication key 118 associated with the third electronic device 108 because the second electronic device 106 and the third electronic device 108 are both associated with the user account of the second user. In some embodiments, the second electronic device 106 receives the authentication key 118 associated with the third electronic device 108 from server 102. In some embodiments, the second electronic device 106 stores the authentication key 118 of the third electronic device 108 in memory of the second electronic device 106. As described herein with reference to FIGS. 1-2, the authentication key 118 of the third electronic device 108 is optionally a key used in wireless communication, such as an identity resolving key used for Bluetooth communication.

At 308, method 300 includes, after receiving the authentication key (e.g., authentication key 118) associated with the third electronic device (e.g., third electronic device 108), receiving, from the third electronic device (e.g., third electronic device 108) via a connection other than a secure device to device connection, an indication of the authentication key (e.g., authentication key 118) associated with the third electronic device (e.g., third electronic device 108). For example, the first electronic device 104 receives an advertisement of the authentication key 118 of the third electronic device 108. Because the first electronic device 104 previously received the authentication key 118 from the second electronic device 106, the first electronic device 104 recognizes the third electronic device 108 based on the advertisement of the authentication key 118, as described in more detail above with reference to FIG. 2. In some embodiments, the third electronic device 108 broadcasts the advertisement using Bluetooth or another wireless protocol other that a connection of the same type as the device to device connection used to receive the authentication key 118 from the second electronic device 106.

At 310, method 300 includes, after receiving the authentication key (e.g., authentication key 118) associated with the third electronic device (e.g., third electronic device 108), receiving, using one or more input devices, an input corresponding to a request to present one or more user interface elements received from the third electronic device (e.g., third electronic device 108). In some embodiments, the input includes an input requesting to activate a feature for presenting content from another electronic device. In some embodiments, the input includes an input selecting the third electronic device 108 as the other electronic device from which to receive content for presentation.

At 312, method 300 includes, after receiving the authentication key (e.g., authentication key 118) associated with the third electronic device (e.g., third electronic device 108), in response to receiving the input and in accordance with one or more criteria being satisfied, presenting, using a display device, the one or more user interface elements received from the third electronic device (e.g., third electronic device 108). In some embodiments, the one or more criteria include a criterion that is satisfied when the first electronic device 104 is operating in the second mode 124 configured for the second user. In some embodiments, if the first electronic device 104 is not operating in the second mode 124 configured for the second user, the first electronic device 104 does not present an option to present content from the third electronic device 108. For example, if the first electronic device 104 is operating in the first mode 122, the first electronic device 104 presents options for presenting content from other devices associated with the user account of the first use, such as the fourth electronic device 110. As another example, if the first electronic device 104 is operating in the second mode 124 configured for a user other than the second user, the first electronic device 104 presents options for presenting content from devices associated with the other user's user account in a manner similar to the manner of presenting content from the third electronic device 108 while the first electronic device 104 is operating in the second mode 124 configured for use by the second user. In some embodiments, the one or more criteria include a criterion that is satisfied when the second mode 124 is configured to allow the presentation of content from another electronic device. For example, it is possible for the first user to configure the first mode 122 with the feature to present content from another electronic device restricted.

As described herein, presenting the one or more user interface elements optionally includes displaying image(s), playing audio, and/or outputting other content received from the third electronic device 108. In some embodiments, the first electronic device 104 displays one or more elements received from the third electronic device 108 associated with the user account of the second user in an environment associated with the user account of the first user. In some embodiments, the one or more elements include two-dimensional images and the environment is a three-dimensional environment. In some embodiments, the one or more elements include three-dimensional images.

FIG. 3B illustrates an exemplary method 320 of presenting content associated with a second user account using an electronic device associated with a first user account according to some embodiments of the disclosure. For example, the first electronic device 104 performs method 320.

At 322, the method 320 includes associating the first electronic device 104 with a first user account. For example, the first user associates the first electronic device 104 with their user account when conducting initial setup of the first electronic device 104. Associating the first electronic device 104 with the first user account includes accessing data associated with the first electronic device 104 and configuring the first electronic device 104 to be unlocked using login credentials of the first user, as described in more detail above.

At 324, the method 320 includes receiving, from a second electronic device 106, an authentication key associated with a second user account different from the first user account. For example, the authentication key is the authentication key 118 associated with the third electronic device 108. As described above, the second electronic device 106 and the third electronic device 108 are both associated with the user account of the second user, whereas the first electronic device 104 is associated with the user account of the first user. In some embodiments, the first electronic device 104 receives the authentication key 118 through a device-to-device connection with the second electronic device 106. In some embodiments, the first electronic device 104 also transmits the authentication key 114 associated with the first electronic device 104 to the second electronic device 106 using the device-to-device connection.

At 326, the method 320 includes using the authentication key associated with the second user account and in accordance with one or more criteria being satisfied, presenting content associated with the second user account. For example, presenting content associated with the second user account includes presenting content from the third electronic device 108. In some embodiments, using the authentication key 118 associated with the second user account includes detecting the advertisement 222 of the authentication key 118 broadcast by the third electronic device 108 and matching the advertisement 222 with authentication key 118. For example, the first electronic device 104 previously received the authentication key 118 from the second electronic device 106. In some embodiments, the one or more criteria include a criterion that is satisfied when the first electronic device 104 operates in the second mode 124 configured for use by the second user. In some embodiments, the one or more criteria include a criterion that is satisfied in response to receiving an input corresponding to a request to present content from another electronic device. In some embodiments, the input includes selecting the third electronic device 108 from a menu of electronic devices available for providing content for presentation by the first electronic device 104.

In some embodiments, the first electronic device 104 deletes the authentication keys associated with the second user account (e.g., authentication keys 116 and/or 118) in accordance with one or more second criteria being satisfied. For example, the one or more second criteria include a criterion that is satisfied when in response to ceasing to operate in the second mode 124 configured for the second user. For example, the first electronic device 104 operates in the first mode 122, locks and does not operate in the first mode 122 or the second mode 124, and/or operates in the second mode 124 configured for a different user. In some embodiments, the one or more second criteria include a criterion that is satisfied when a predetermined time has passed since ceasing to operate in the second mode 124 configured for the second user, such as an hour, a day, or a week. In some embodiments, the one or more second criteria include a criterion that is satisfied when the first electronic device 104 is more than a predetermined distance away from the second electronic device 106 and/or the third electronic device 108. In some embodiments, the one or more second criteria include a criterion that is satisfied when the device-to-device connection between the first electronic device 104 and the second electronic device 106 is terminated.

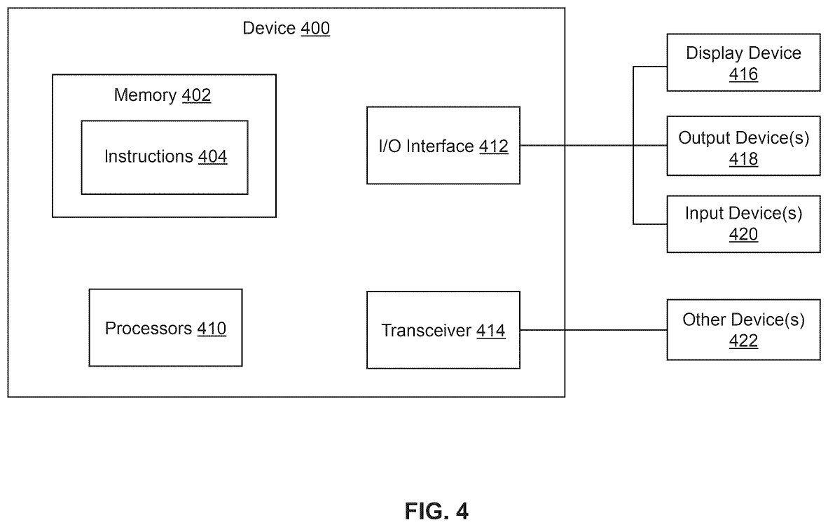

FIG. 4 is an example block diagram of an electronic device 400 according to some embodiments of the disclosure. The first electronic device 104 described above with reference to FIG. 1 optionally shares the same architecture as electronic device 400. However, it is possible for the first electronic device 104 to include more, fewer, or different components than shown in the architecture of electronic device 400. The electronic device 400 includes memory 402, one or more processors 410, I/O interface 412, and transceiver 414.

Memory 402 of electronic device 400 includes volatile and/or non-volatile memory implemented using electronic, electromagnetic, magnetic, infrared, optical, and/or semiconductor system(s) and/or device(s). Examples of suitable memory circuitry include random access memory (RAM) devices (e.g., static random-access memory (SRAM), double-data-rate random-access memory (DDR RAM), dynamic random-access memory (DRAM), or other high-speed RAM or solid-state RAM, etc.), flash memory devices, read-only memory (ROM) devices, or erasable or electrically erasable programmable read-only memory devices (EPROM or EEPROM). Other types of memory are possible. Memory 402 is optionally separate from the one or more other components of electronic device 400 and electrically coupled to the one or more other components of electronic device 400 for read and/or write operations. Some of memory 402 is optionally integrated within other components of electronic device 400.

At least a portion of the memory 402 can be referred as a computer-readable storage medium. Memory 402 and/or a transitory or non-transitory computer readable storage medium of memory 402 optionally store instructions, programs, data structures and/or modules or a subset or combination thereof. Memory 402 and/or the computer readable storage medium optionally store instructions 404 and/or programs, which when executed by processors 410, cause the electronic device 400 (or a computing system more generally) to perform one or more functions and methods of one or more examples of this disclosure, such as one or more of the methods described herein with reference to FIGS. 1-3. As used herein, a “non-transitory computer-readable storage medium” includes any tangible medium (e.g., excluding signals) that can contain or store programs/instructions for use by the electronic device (e.g., processing circuitry), for example.

The electronic device 400 further includes one or more processors 410. Processors 410 optionally include graphics processing units (GPUs), central processing units (CPUs), microprocessors, microcontrollers, programmable logic device (PLD), field-programmable gate arrays (FPGAs), application specific integrated circuits (ASICs), digital signal processors (DSPs), or any suitable processing circuitry. The electronic device 400 uses processors 410 to perform any of the functions, processes, and/or methods described herein (e.g., optionally by executing instructions or programs stored in memory 402 and/or a non-transitory computer-readable storage medium).

The electronic device 400 further includes an I/O interface 412. I/O interface 412 includes circuitry such as data lines, address lines, and control lines, for example, which enables communication between the electronic device 400 and one or more peripherals, such as display device 416, output device(s) 418, and input device(s) 420. Example display devices include, but are not limited to, monitors, television screens, touch screens, projectors, and/or head mounted displays implemented with LCD (liquid crystal display), LED (light emitting diode), OLED (organic light emitting diode), and/or other technology. Examples of other output device(s) 418 include, but are not limited to audio output devices (e.g., wired and/or wireless speakers and/or headphones), tactile output devices (e.g., haptic and/or vibration devices), and other visual output devices (e.g., indicator lights). Example input device(s) 420 include camera(s) (e.g., visible light cameras and/or infrared cameras), depth sensors (e.g., range sensors and/or LiDAR), trackpads, mouses, touch screens, microphones, keyboards, pedals, remote controls, and/or video game controllers.

The electronic device 400 includes a transceiver 414 (e.g., wired and/or wireless communication circuitry). Transceiver 414 includes transmitter and/or receiver circuitry, including but not limited to signal generator(s), oscillator(s), modulator(s), encoder(s), amplifier(s), antenna(s), demodulator(s), filter(s), decoder(s), and/or tuner(s), for example. In some embodiments, the transceiver 414 is configured to communicate with other device(s) 422 using one or more protocols, including but not limited to secure device to device connections, Bluetooth, Wi-Fi, Wi-Fi Direct, radio, cellular communication, satellite communication, and/or wired communication.

As described above, the components and configuration of components of electronic device 400 according to the disclosure are not limited by the example illustrated and described with reference to FIG. 4. In some embodiments, one or more of the components of the electronic device 400 included in FIG. 4 and any additional components of the electronic device 400 not shown in FIG. 4 are in communication with each other and/or integrated with each other. In some embodiments, additional or alternative components and/or configurations are possible.

Aspects of the disclosure relate to communication between electronic devices. Handling of information included in this communication should meet or exceed privacy practices according to their relevant industry and/or government regulations. In some embodiments, sharing of personal information can be blocked and/or prevented without departing from the scope of the disclosure. For example, users may opt out of sharing personal information when allowing devices to communicate and/or authentication modalities other than communication between devices can be used.

Some examples of the disclosure are related to an electronic device, comprising: memory; and one or more processors coupled to the memory, wherein the one or more processors are configured to: associate the electronic device with a first user account; receive, from a second electronic device, an authentication key associated with a second user account different from the first user account; and using the authentication key associated with the second user account and in accordance with one or more criteria being satisfied, present content associated with the second user account. Additionally or alternatively, in some examples receiving the authentication key includes: establishing, with the second electronic device, a device to device connection; and after establishing the device to device connection with the second electronic device, transmitting, to the second electronic device, an authentication key associated with the electronic device using the device to device connection. Additionally or alternatively, in some examples the one or more criteria include a criterion that is satisfied when the electronic device is operating in a mode for access by a user associated with the second user account, and is not satisfied when the electronic device is operating in a mode for access by a user associated with the first user account. Additionally or alternatively, in some examples the one or more criteria include a criterion that is satisfied in response to receiving, using one or more input devices, an input corresponding to a request to present the content associated with the second user account, and the one or more processors are further configured to: in response to receiving the input corresponding to the request to present the content associated with the second user account: transmit, to a third electronic device associated with the second user account, an indication of an authentication key associated with the electronic device. Additionally or alternatively, in some examples the one or more criteria includes a criterion that is satisfied in response to receiving, from a third electronic device associated with the second user account, an indication of the authentication key associated with the second user account that matches the authentication key associated with the second user account received from the second electronic device. Additionally or alternatively, in some examples presenting the content associated with the second user account includes presenting the content associated with the second user account in an environment that is based on data associated with the first user account. Additionally or alternatively, in some examples the one or more criteria include a criterion that is satisfied in response to receiving, using one or more input devices, an input corresponding to a request to present the content associated with the second user account that includes receiving selection of a third device associated with the second user account from a list of a plurality of devices available from which to receive content for presentation. Additionally or alternatively, in some examples the one or more processors are further configured to, in accordance with one or more second criteria being satisfied, delete the authentication key associated with the second user account.

Some examples of the disclosure are directed to a method, comprising: at an electronic device including memory and one or more processors coupled to the memory: associating the electronic device with a first user account; receiving, from a second electronic device, an authentication key associated with a second user account different from the first user account; and using the authentication key associated with the second user account and in accordance with one or more criteria being satisfied, presenting content associated with the second user account. Additionally or alternatively, in some examples receiving the authentication key includes: establishing, with the second electronic device, a device to device connection; and after establishing the device to device connection with the second electronic device, transmitting, to the second electronic device, an authentication key associated with the electronic device using the device to device connection. Additionally or alternatively, in some examples the one or more criteria include a criterion that is satisfied when the electronic device is operating in a mode for access by a user associated with the second user account, and is not satisfied when the electronic device is operating in a mode for access by a user associated with the first user account. Additionally or alternatively, in some examples the one or more criteria include a criterion that is satisfied in response to receiving, using one or more input devices, an input corresponding to a request to present the content associated with the second user account, and the method further comprises: in response to receiving the input corresponding to the request to present the content associated with the second user account: transmitting, to a third electronic device associated with the second user account, an indication of an authentication key associated with the electronic device. Additionally or alternatively, in some examples the one or more criteria includes a criterion that is satisfied in response to receiving, from a third electronic device associated with the second user account, an indication of the authentication key associated with the second user account that matches the authentication key associated with the second user account received from the second electronic device. Additionally or alternatively, in some examples presenting the content associated with the second user account includes presenting the content associated with the second user account in an environment that is based on data associated with the first user account. Additionally or alternatively, in some examples the one or more criteria include a criterion that is satisfied in response to receiving, using one or more input devices, an input corresponding to a request to present the content associated with the second user account that includes receiving selection of a third device associated with the second user account from a list of a plurality of devices available from which to receive content for presentation. Additionally or alternatively, in some examples the method includes, in accordance with one or more second criteria being satisfied, deleting the authentication key associated with the second user account.

Some embodiments are directed to a non-transitory computer readable storage medium storing instructions, which when executed by an electronic device that includes memory and one or more processors coupled to the memory, cause the electronic device to perform one or more method(s), process(es), and/or step(s) described herein.

1. An electronic device, comprising:
memory; and
one or more processors coupled to the memory, wherein the one or more processors are configured to:
associate the electronic device with a first user account;
receive, from a second electronic device, an authentication key associated with a second user account different from the first user account; and
using the authentication key associated with the second user account and in accordance with one or more criteria being satisfied, present content associated with the second user account.

2. The electronic device of claim 1, wherein receiving the authentication key includes:
establishing, with the second electronic device, a device to device connection; and
after establishing the device to device connection with the second electronic device, transmitting, to the second electronic device, an authentication key associated with the electronic device using the device to device connection.

3. The electronic device of claim 1, wherein the one or more criteria include a criterion that is satisfied when the electronic device is operating in a mode for access by a user associated with the second user account, and is not satisfied when the electronic device is operating in a mode for access by a user associated with the first user account.

4. The electronic device of claim 1, wherein the one or more criteria include a criterion that is satisfied in response to receiving, using one or more input devices, an input corresponding to a request to present the content associated with the second user account, and the one or more processors are further configured to:
in response to receiving the input corresponding to the request to present the content associated with the second user account:
transmit, to a third electronic device associated with the second user account, an indication of an authentication key associated with the electronic device.

5. The electronic device of claim 1, wherein the one or more criteria includes a criterion that is satisfied in response to receiving, from a third electronic device associated with the second user account, an indication of the authentication key associated with the second user account that matches the authentication key associated with the second user account received from the second electronic device.

6. The electronic device of claim 1, wherein presenting the content associated with the second user account includes presenting the content associated with the second user account in an environment that is based on data associated with the first user account.

7. The electronic device of claim 1, wherein the one or more criteria include a criterion that is satisfied in response to receiving, using one or more input devices, an input corresponding to a request to present the content associated with the second user account that includes receiving selection of a third device associated with the second user account from a list of a plurality of devices available from which to receive content for presentation.

8. A method, comprising:
at an electronic device including memory and one or more processors coupled to the memory:
associating the electronic device with a first user account;
receiving, from a second electronic device, an authentication key associated with a second user account different from the first user account; and
using the authentication key associated with the second user account and in accordance with one or more criteria being satisfied, presenting content associated with the second user account.

9. The method of claim 8, wherein receiving the authentication key includes:
establishing, with the second electronic device, a device to device connection; and
after establishing the device to device connection with the second electronic device, transmitting, to the second electronic device, an authentication key associated with the electronic device using the device to device connection.

10. The method of claim 8, wherein the one or more criteria include a criterion that is satisfied when the electronic device is operating in a mode for access by a user associated with the second user account, and is not satisfied when the electronic device is operating in a mode for access by a user associated with the first user account.

11. The method of claim 8, wherein the one or more criteria include a criterion that is satisfied in response to receiving, using one or more input devices, an input corresponding to a request to present the content associated with the second user account, and the method further comprises:
in response to receiving the input corresponding to the request to present the content associated with the second user account:
transmitting, to a third electronic device associated with the second user account, an indication of an authentication key associated with the electronic device.

12. The method of claim 8, wherein the one or more criteria includes a criterion that is satisfied in response to receiving, from a third electronic device associated with the second user account, an indication of the authentication key associated with the second user account that matches the authentication key associated with the second user account received from the second electronic device.

13. The method of claim 8, wherein presenting the content associated with the second user account includes presenting the content associated with the second user account in an environment that is based on data associated with the first user account.

14. The method of claim 8, wherein the one or more criteria include a criterion that is satisfied in response to receiving, using one or more input devices, an input corresponding to a request to present the content associated with the second user account that includes receiving selection of a third device associated with the second user account from a list of a plurality of devices available from which to receive content for presentation.

15. A non-transitory computer readable storage medium storing instructions that, when executed by one or more processors of an electronic device cause the electronic device to perform a method including:
associating the electronic device with a first user account;
receiving, from a second electronic device, an authentication key associated with a second user account different from the first user account; and
using the authentication key associated with the second user account and in accordance with one or more criteria being satisfied, presenting content associated with the second user account.

16. The non-transitory computer readable storage medium of claim 15, wherein the one or more criteria include a criterion that is satisfied when the electronic device is operating in a mode for access by a user associated with the second user account, and is not satisfied when the electronic device is operating in a mode for access by a user associated with the first user account.

17. The non-transitory computer readable storage medium of claim 15, wherein the one or more criteria include a criterion that is satisfied in response to receiving, using one or more input devices, an input corresponding to a request to present the content associated with the second user account, and the method further comprises:
in response to receiving the input corresponding to the request to present the content associated with the second user account:
transmitting, to a third electronic device associated with the second user account, an indication of an authentication key associated with the electronic device.

18. The non-transitory computer readable storage medium of claim 15, wherein the one or more criteria includes a criterion that is satisfied in response to receiving, from a third electronic device associated with the second user account, an indication of the authentication key associated with the second user account that matches the authentication key associated with the second user account received from the second electronic device.

19. The non-transitory computer readable storage medium of claim 15, wherein presenting the content associated with the second user account includes presenting the content associated with the second user account in an environment that is based on data associated with the first user account.

20. The non-transitory computer readable storage medium of claim 15, wherein the one or more criteria include a criterion that is satisfied in response to receiving, using one or more input devices, an input corresponding to a request to present the content associated with the second user account that includes receiving selection of a third device associated with the second user account from a list of a plurality of devices available from which to receive content for presentation.
